(19) United States
(12) Patent Application Publication
(10) Pub. No.: US 2013/0288125 A1
(43) Pub. Date: Oct. 31, 2013

(54) POSITIVE ELECTRODE FOR RECHARGEABLE LITHIUM BATTERY, RECHARGEABLE LITHIUM BATTERY INCLUDING SAME AND METHOD OF PREPARING RECHARGEABLE LITHIUM BATTERY

(71) Applicant: SAMSUNG SDI CO., LTD., Yongin-si (KR)

(72) Inventors: Kyeu-Yoon SHEEM, Yongin-si (KR); Jake KIM, Yongin-si (KR)

(73) Assignee: SAMSUNG SDI CO., LTD., Yongin-si (KR)

(21) Appl. No.: 13/749,150

(22) Filed: Jan. 24, 2013

(30) Foreign Application Priority Data
Apr. 30, 2012 (KR) 10-2012-0045835

(51) Int. Cl. H01M 4/62; H01M 10/04

(52) U.S. Cl. CPC H01M 4/628; H01M 10/04
USPC 429/212; 205/59

(57) ABSTRACT

A positive electrode for a rechargeable lithium battery includes a positive active material, and a solid electrolyte interface (SEI) passivation film including an inorganic material and an organic material, the SEI passivation film having an average thickness of about 1 nm to about 20 nm on a surface of the electrode.

### CROSS-REFERENCE TO RELATED APPLICATION

This application claims priority under 35 U.S.C. §119 to Korean Patent Application No. 10-2012-0045835, filed in the Korean Intellectual Property Office on Apr. 30, 2012, the entire contents of which are incorporated herein by reference.

### BACKGROUND

1. Field

Embodiments relate to a positive electrode for a rechargeable lithium battery, a rechargeable lithium battery including the same, and a method of preparing a rechargeable lithium battery.

2. Description of the Related Art

Due to reductions in size and weight of portable electronic equipment, batteries for the portable electronic equipment that have both high performance and large capacity have been considered. The rechargeable lithium battery includes a positive electrode including a positive active material capable of intercalating/deintercalating lithium ions and a negative electrode including a negative active material capable of intercalating/deintercalating lithium ions, and an electrolyte.

### SUMMARY

Embodiments are directed to a positive electrode for a rechargeable lithium battery including a positive active material layer including a positive active material, and a solid electrolyte interface (SEI) passivation film on a surface of the positive active material layer. The SEI passivation film includes an inorganic material and an organic material, the SEI passivation film having an average thickness of about 1 nm to about 20 nm.

The inorganic material may include at least one selected from LiF, Li₂O, Li₂CO₃ and LiₓPF_{y}O (0<x≦1, 1≦y≦4). The organic material may include at least one selected from ROCO₂Li, where R is a C1 to C10 alkyl group, R¹(OCO₂CH₂CH₂)ₙLi, where R¹ is a C1 to C10 alkyl group, and n is an integer ranging from about 1 to about 25, R²(CH₂CH₂O)ₘLi, where R² is a C1 to C10 alkyl group, and m is an integer ranging from about 1 to about 25, and NR³R⁴R⁵, where R³, R⁴ and R⁵ are C1 to C10 alkyl groups.

The positive active material may include at least one lithium composite oxide selected from LiCoO₂, LiₐNi_{b}Co_{c}Al_{d}O₂ (0.9≦a≦1.1, 0.1≦b≦2.0, 0.01≦c≦1.0, 0.01≦d≦1.0, b+c+d=1), and LiFePO₄. The positive active material may further include activated carbon.

The SEI passivation film may include about 50 to about 90 wt % of LiF based on a total amount of the SEI passivation film.

A first layer of the SEI passivation film may include the organic material in an amount greater than or equal to about 90 wt % and the inorganic material in an amount of less than or equal to about 10 wt %. A second layer of the SEI passivation film may include the inorganic material in an amount greater than or equal to about 80 wt % and the organic material in an amount of less than or equal to about 20 wt %. The first layer and the second layer are determined according to a division of the SEI passivation film based on an equal thickness, the first layer being in a positive active material direction from a surface of the SEI passivation film and the second layer being between the first layer and the positive active material.

A rechargeable lithium battery may include the positive electrode, a negative electrode, and an electrolyte.

The SEI passivation film on the surface of the positive electrode may be formed through a formation process in which the rechargeable lithium battery is charged and discharged several times at an about 3.0V to about 4.2V relative to a lithium metal. When the rechargeable lithium battery is charged at about 3.3V to about 4.0V after the formation process, the SEI passivation film may include about 50 to about 90 wt % of LiF based on a total weight of the SEI passivation film. When the rechargeable lithium battery is discharged at about 3.3V to about 4.0V after the formation process, the SEI passivation film includes about 50 to about 90 wt % of LiF based on a total weight of the SEI passivation film.

Embodiments are also directed to a method of preparing a rechargeable lithium battery, the method including providing a battery precursor including an electrode assembly, a positive electrode including a positive active material, a negative electrode and an electrolyte in a battery case, and performing a formation process where the battery precursor is charged and discharged at an about 3.0V to about 4.2V region relative to a lithium metal to form a solid electrolyte interface (SEI) passivation film including an inorganic material and an organic material and having an average thickness of about 1 nm to about 20 nm on a surface of the positive electrode.

The method may further include charging the rechargeable lithium battery at about 3.3V to about 4.0V after the formation process. The SEI passivation film after the charging may include about 50 to about 90 wt % of LiF based on a total weight of the SEI passivation film.

The method may further include discharging the rechargeable lithium battery at about 3.3V to about 4.0V after the formation process. The SEI passivation film after the discharging may include about 50 to about 90 wt % of LiF based on a total weight of the SEI passivation film.

### BRIEF DESCRIPTION OF THE DRAWING

Features will become apparent to those of skill in the art by describing in detail exemplary embodiments with reference to the attached drawing in which:

FIG. 1 illustrates a schematic, cutaway view showing the rechargeable lithium battery according to an embodiment.

### DETAILED DESCRIPTION

Example embodiments will now be described more fully hereinafter with reference to the accompanying drawing; however, they may be embodied in different forms and should not be construed as limited to the embodiments set forth herein. Rather, these embodiments are provided so that this disclosure will be thorough and complete, and will fully convey the scope thereof to those skilled in the art. In the drawing figure, the dimensions of layers and regions may be exaggerated for clarity of illustration.

The positive electrode for a rechargeable lithium battery according to an embodiment may include a SEI (solid electrolyte interface) passivation film on a surface thereof. That is, the positive electrode includes a positive active material layer and the SEI passivation film on a surface of the positive active material layer. The SEI passivation film may have an average thickness ranging from about 1 nm to about 20 nm, specifically about 1 nm to about 15 nm, and more specifically about 5 nm to about 15 nm. When the SEI passivation film having an average thickness within the range is formed on the surface of a positive electrode, the positive electrode may resist deterioration due to volume changes of the positive active material during the charge and discharge at a high-rate of greater than or equal to about 5 C. The SEI passivation film may also help to suppress gas generation, substrate detachment, and the like, providing a rechargeable lithium battery that may be operated without degradation during repetitive high-rate charge and discharge.

The SEI passivation film having an average thickness within the range may be formed through a formation process where the rechargeable lithium battery is charged and discharged several times in a region ranging from about 3.0 V to about 4.2 V relative to a lithium metal.

In the one embodiment, the thickness of the SEI passivation film refers to a distance between the surface of the SEI passivation on the positive active material and an interface in the direction of the positive active material. The interface may be defined by the following Equation 1 using an XPS, and in the embodiment, D indicates to about 50% to about 70%.

Interface(D)=The amount of A component in C/C [Equation 1]

A: Positive active material

C: Index, intensity, measured in an XPS

The SEI passivation film may include an inorganic material and an organic material.

The inorganic material may include at least one selected from LiF, Li₂O, Li₂CO₃, and LiₓPF_{y}O(0<x≦1, 1≦y≦4).

The organic material may include at least one selected from ROCO₂Li (R is a C1 to C10 alkyl group), R¹(OCO₂CH₂CH₂)ₙLi (R¹ is a C1 to C10 alkyl group, and n is an integer ranging from about 1 to about 25), R²(CH₂CH₂O)ₘLi (R² is a C1 to C10 alkyl group, and m is an integer ranging from about 1 to about 25), and NR³R⁴R⁵ (R³, R⁴ and R⁵ are C1 to C10 alkyl groups).

The SEI passivation film may include LiF in an amount ranging from about 50 wt % to about 90 wt % and specifically about 75 wt % to about 85 wt %, based on a total weight of the SEI passivation film. When the SEI passivation film is adjusted to include LiF within the range, a SEI passivation film component may be prevented from being detached and re-attached to form a thicker SEI passivation film, resultantly suppressing performance degradation of the battery during high-rate charge and discharge.

The SEI passivation film having the above-described composition may be formed through a formation process in which the rechargeable lithium battery is charged and discharged several times within a region ranging from about 3.0V to about 4.2V relative to a lithium metal.

In addition, the SEI passivation film may include different components in various amounts depending on a location with respect to a thickness thereof through a formation process under the condition.

For example, the SEI passivation film may be considered as having two layers having an equal thickness, a first layer extending from the surface of the SEI passivation film in a positive active material direction and a second layer being beneath the first layer. The second layer may be between the first layer and the positive active material. The first layer may include the organic material in an amount greater than or equal to about 90 wt % and the inorganic material in an amount of less than or equal to about 10 wt %, while the second layer may include the inorganic material in an amount greater than or equal to about 80 wt % and the organic material in an amount of less than or equal to about 20 wt %.

The first layer of the SEI passivation film may include NR³R⁴R⁵, where R³, R⁴ and R⁵ are C1 to C10 alkyl groups, in an amount greater than or equal to about 90 wt % based on a total weight of the first layer, while the second layer of the SEI passivation film may include LiF in an amount greater than or equal to about 80 wt % based on a total weight of the second layer.

The SEI passivation film on the surface of the positive electrode may have an average thickness within the predetermined range, and simultaneously, the predetermined component and its amount and may be formed through a formation process in which a rechargeable lithium battery including the positive electrode is charged and discharged several times at a voltage within the predetermined range.

For example, through a formation process where a rechargeable lithium battery is charged and discharged several times at an about 3.0V to about 4.2V relative to a lithium metal, the SEI passivation film may be formed. More specifically, the formation process may be performed by charging and discharging the rechargeable lithium battery about 1 to 10 times in a region ranging from about 3.5V to about 4.0V for about 10 minutes to about 5 hours. The charging may be performed in a method of charging and discharging with a constant current, pulse charge and discharge, or charge and discharge in steps. The formation process of charging and discharging a rechargeable lithium battery several times at a voltage within the range may adjust the composition of a SEI passivation film as well as provide for the forming of the SEI passivation film having an average thickness within the predetermined range and high density. Accordingly, the formation process may help prevent components of the SEI passivation film from being detached from, and reattached to, the surface of a positive active material during high-rate charge and discharge, and thus making the SEI passivation film thicker again. Accordingly, a rechargeable lithium battery having excellent battery performance during the high-rate charge and discharge may be provided.

An average thickness and composition of the SEI passivation film may be measured using a film analyzer. The film analyzer may include an inert chamber in which an inert atmosphere is controlled and maintained to have moisture ranging from about 0 ppm to about 0.1 ppm and oxygen ranging from about 0 ppm to about 0.5 ppm and in which a pretreatment is performed; a first analyzer connected to the inert chamber, the first analyzer being provided with a specimen under the inert atmosphere and including an X-ray photoelectron spectroscopy (XPS) equipment; an inert holder assembled with the specimen in the inert chamber and maintaining the inert atmosphere around the specimen; and a second analyzer inside of which the inert holder is mounted and which includes a scanning electron microscope (SEM).

The film analyzer may be used to measure average thickness and composition of the SEI passivation film by the following method.

The measurement may include pretreating a specimen in an inert chamber, transferring the specimen into the first analyzer to measure an average thickness and a composition of the SEI passivation film, transferring the specimen into the inert chamber to be assembled with the inert holder, and mounting the inert holder on the second analyzer to examine shape information of the SEI passivation film.

The pretreatment of the specimen may include obtaining an electrode by disassembling a rechargeable lithium battery after the formation process, cutting an electrode therein into a predetermined size to prepare a specimen, cleaning the specimen, and assembling the specimen with a supporting substrate or the inert holder.

The specimen may be ion-etched in the first analyzer before being transferred into the inert chamber. In the ion etching, an ion beam may be radiated at an accelerating voltage ranging from about 0.3 kV to about 0.5 kV with a current ranging from about 0.2 μA to about 0.5 μA. In addition, the ion beam may be radiated until the positive electrode material beneath the SEI passivation film is reduced to about 50 to about 70 atom % based on the total weight of the original positive electrode material during the ion etching.

The second analyzer may radiate an electron beam at an accelerating voltage ranging from about 0.5 kV to about 1.0 kV with a current ranging from about 1 pA to about 15 pA.

The film analyzer may be used to analyze the shape, thickness, and composition of the SEI passivation film with high precision in a short time without doing damage to the film in the pretreatment.

The positive active material layer may include a positive active material, a binder, and a conductive material. The positive electrode further includes a current collector supporting the positive active material layer, and the current collector may be Al (aluminum), as an example.

The positive active material may include a compound that reversibly intercalates and deintercalates lithium (a lithiated intercalation compound). Examples include LiₐA_{1-b}B_{b}D₂ (0.90≦a≦1.8 and 0≦b≦0.5); LiₐE_{1-b}B_{b}O_{2-c}D_{c} (0.90≦a≦1.8, 0≦b≦0.5, 0≦c≦0.05); LiE_{2-b}B_{b}O_{4-c}D_{c} (0≦b≦0.5, 0≦c≦0.05); LiₐNi_{1-b-c}Co_{b}B_{c}D_{α} (0.90≦a≦1.8, 0≦b≦0.5, 0≦c≦0.05, 0≦α≦2); LiₐNi_{1-b-c}Co_{b}B_{c}O_{2-α}F_{α} (0.90≦a≦1.8, 0≦b≦0.5, 0≦c≦0.05, 0≦α<2); LiₐNi_{1-b-c}Co_{b}B_{c}O_{2-α}F₂ (0.90≦a≦1.8, 0≦b≦0.5, 0≦c≦0.05, 0<α<2); LiₐNi_{1-b-c}Mn_{b}B_{c}D_{α} (0.90≦a≦1.8, 0≦b≦0.5, 0≦c≦0.05, 0<α≦2); LiₐNi_{1-b-c}Mn_{b}B_{c}O_{2-α}F_{α} (0.90≦a≦1.8, 0≦b≦0.5, 0≦c≦0.05, 0<α<2); LiₐNi_{1-b-c}Mn_{b}B_{c}O_{2-α}F₂ (0.90≦a≦1.8, 0≦b≦0.5, 0≦c≦0.05, 0<α<2); LiₐNi_{b}E_{c}G_{d}O₂ (0.90≦a≦1.8, 0≦b≦0.9, 0≦c≦0.5, 0.001≦d≦0.1); LiₐNi_{b}Co_{c}Mn_{d}GeO₂ (0.90≦a≦1.8, 0≦b≦0.9, 0≦c≦0.5, 0≦d≦0.5, 0.001≦e≦0.1); LiₐNiG_{b}O₂ (0.90≦a≦1.8, 0.001≦b≦0.1); LiₐCoG_{b}O₂ (0.90≦a≦1.8, 0.001≦b≦0.1); LiₐMnG_{b}O₂ (0.90≦a≦1.8, 0.001≦b≦0.1); LiₐMn₂G_{b}O₄ (0.90≦a≦1.8, 0.001≦b≦0.1); QS₂; LiQS₂; V₂O₅; LiV₂O₅; LiIO₂; LiNiVO₄; Li_{(3-f)}J₂(PO₄)₃ (0≦f≦2); Li_{(3-f)}Fe₂(PO₄)₃ (0≦f≦2); or LiFePO₄.

In the above formulae, A is Ni, Co, Mn, or a combination thereof; B is Al, Ni, Co, Mn, Cr, Fe, Mg, Sr, V, a rare earth element, or a combination thereof; D is O, F, S, P, or a combination thereof; E is Co, Mn, or a combination thereof; F is F, S, P, or a combination thereof; G is Al, Cr, Mn, Fe, Mg, La, Ce, Sr, V, or a combination thereof; Q is Ti, Mo, Mn, or a combination thereof; I is Cr, V, Fe, Sc, Y, or a combination thereof; and J is V, Cr, Mn, Co, Ni, Cu or combination thereof.

In an embodiment, the positive active material may include at least one selected from LiCoO₂, LiₐNi_{b}Co_{c}Al_{d}O₂ (0.9≦a≦1.1, 0.1≦b≦2.0, 0.01≦c≦1.0, 0.01≦d≦1.0, b+c+d=1), and LiFePO₄.

The positive active material may include activated carbon along with the compound. The term “activated carbon” may refer to a carbon-based material including shapeless carbon in which graphite-shaped flat crystallites are complicatedly combined, being porous, and having a specific surface area and high adsorption capability.

The binder may improve binding properties of the positive active material particles to each other and to a current collector. Examples of the binder include polyvinylalcohol, carboxylmethylcellulose, hydroxypropylcellulose, diacetylcellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, or the like.

The conductive material may provide an electrode with conductivity. Any suitable electrically conductive material that does not cause a chemical change may be used as a conductive material. Examples of the conductive material include one or more of natural graphite, artificial graphite, carbon black, acetylene black, ketjen black, a carbon fiber, copper, a metal powder or a metal fiber including nickel, aluminum, silver, or the like, or a polyphenylene derivative.

The positive electrode may be fabricated by a method including mixing an active material, a conductive material, and a binder into an active material composition and coating the composition on a current collector.

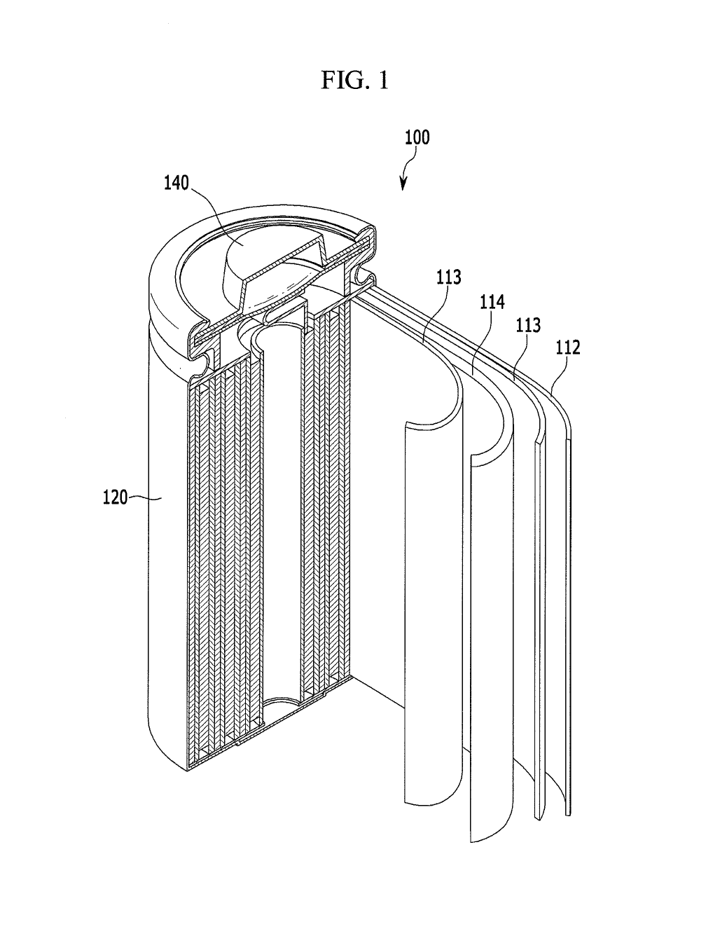

Hereinafter, a rechargeable lithium battery including the positive electrode is described referring to FIG. 1.

FIG. 1 illustrates a schematic, cutaway view showing a rechargeable lithium battery according to an embodiment. Referring to FIG. 1, a rechargeable lithium battery 100 according to an embodiment may include an electrode assembly including a positive electrode 114, a negative electrode 112 facing the positive electrode 114, a separator 113 interposed between the positive electrode 114 and negative electrode 112, and an electrolyte impregnating the positive electrode 114, negative electrode 112, and separator 113, a battery case 120 housing the electrode assembly, and a sealing member 140 sealing the battery case 120.

The positive electrode 114 is the same as described above.

The negative electrode 112 may include a current collector and a negative active material layer disposed on the current collector.

The current collector may include a copper foil, a nickel foil, a stainless steel foil, a titanium foil, a nickel foam, a copper foam, a polymer substrate coated with a conductive metal, or combinations thereof, as examples.

The negative active material layer may include a negative active material and a binder. In another implementation, the negative active material layer may include a negative active material, a binder and a conductive material.

The negative active material may include a material that reversibly intercalates/deintercalates lithium ions, a lithium metal, a lithium metal alloy, a material being capable of doping and dedoping lithium, or a transition metal oxide.

The material that reversibly intercalates/deintercalates lithium ions may include carbon materials. The carbon material may be any generally-used carbon-based negative active material in a lithium ion rechargeable battery. Examples of the carbon material include crystalline carbon, amorphous carbon, and a mixture thereof. The crystalline carbon may be shapeless, or may be a sheet, flake, spherical, or fiber-shaped natural graphite or artificial graphite. The amorphous carbon may be a soft carbon, a hard carbon, a mesophase pitch carbonized product, fired coke, or the like.

Examples of the lithium metal alloy include lithium and a metal selected from Na, K, Rb, Cs, Fr, Be, Mg, Ca, Sr, Si, Sb, Pb, In, Zn, Ba, Ra, Ge, Al, and Sn.

Examples of the material being capable of doping and dedoping lithium include Si, SiOₓ (0<x<2), a Si—Y alloy (where Y is an element selected from the group consisting of an alkali metal, an alkaline-earth metal, Group 13 to 16 elements, a transition element, a rare earth element, and combinations thereof, and is not Si), Sn, SnO₂, a Sn—Y alloy (where Y is an element selected from the group consisting of an alkali metal, an alkaline-earth metal, Group 13 to 16 elements, a transition element, a rare earth element, and combinations thereof and is not Sn), or mixtures thereof. At least one of these materials may be mixed with SiO₂. The element Y may include one selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof.

Examples of the transition metal oxide include vanadium oxide, lithium vanadium oxide, or the like.

The binder may improve binding properties of the negative active material particles to each other and to a current collector. Examples of the binder include at least one selected from the group consisting of polyvinyl alcohol, carboxylmethyl cellulose, hydroxypropyl cellulose, polyvinyl chloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, or the like.

The conductive material may be used to provide an electrode with conductivity. Any suitable electrically conductive material that does not cause chemical change may be used as a conductive material. Examples of the conductive material include carbon-based materials such as natural graphite, artificial graphite, carbon black, acetylene black, ketjen black, a carbon fiber, or the like; a metal-based material of a metal powder or a metal fiber including copper, nickel, aluminum, silver, or the like; a conductive polymer such as a polyphenylene derivative; or mixtures thereof.

The negative electrode 112 may be fabricated by a method including mixing an active material, a conductive material, and a binder to provide an active material composition, and coating the composition on a current collector. A solvent such as N-methylpyrrolidone, for example, may be used in forming the negative electrode 112.

The electrolyte may include a non-aqueous organic solvent and a lithium salt.

The non-aqueous organic solvent may serve as a medium for transferring ions taking part in the electrochemical reaction of the battery. The non-aqueous organic solvent may include a carbonate-based, ester-based, ether-based, ketone-based, alcohol-based, or aprotic solvent.

Examples of the carbonate-based solvent include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), etc. Examples of the ester-based solvent include methyl acetate, ethyl acetate, n-propyl acetate, dimethylacetate, methylpropionate, ethylpropionate, γ-butyrolactone, decanolide, valerolactone, mevalonolactone, caprolactone, or the like.

When a linear carbonate compound and a cyclic carbonate compound are mixed with each other, the dielectric constant may increase and the viscosity may decrease. The cyclic carbonate compound and linear carbonate compound may be mixed together in the volume ratio of about 1:1 to about 1:9.

Examples of the ester-based solvent include methyl acetate, ethyl acetate, n-propyl acetate, dimethylacetate, methylpropionate, ethylpropionate, γ-butyrolactone, decanolide, valerolactone, mevalonolactone, caprolactone, and the like. Examples of the ether-based solvent include dibutyl ether, tetraglyme, diglyme, dimethoxyethane, 2-methyltetrahydrofuran, tetrahydrofuran, or the like. Examples of the ketone-based solvent include cyclohexanone or the like. Examples of the alcohol-based solvent include ethyl alcohol, isopropyl alcohol, or the like.

The non-aqueous organic solvent may be used singularly or in a mixture. When the organic solvent is used in a mixture, the mixture ratio may be controlled in accordance with a desirable battery performance.

The non-aqueous electrolyte solution may further include an overcharge-inhibiting compound such as ethylene carbonate, pyrocarbonate, and the like.

The lithium salt may supply lithium ions in the battery and may perform a basic operation of a rechargeable lithium battery. The lithium salt may also improve lithium ion transport between positive and negative electrodes.

Examples of the lithium salt include LiPF₆, LiBF₄, LiSbF₆, LiAsF₆, LiN(SO₃C₂F₅)₂, LiC₄F₉SO₃, LiClO₄, LiAlO₂, LiAlCl₄, LiN(CₓF₂ₓ₊₁SO₂)(C_{y}F_{2y+1}SO₂), where x and y are natural numbers, LiCl, LiI, LiB(C₂O₄)₂ (lithium bisoxalate borate, LiBOB), or a combination thereof.

The lithium salt may be used at a concentration ranging from about 0.1 to about 2.0M. When the lithium salt is included at the concentration range, electrolyte performance and lithium ion mobility may be enhanced due to optimal electrolyte conductivity and viscosity.

The separator 113 may be formed as a single layer or a multilayer, and may be made of polyethylene, polypropylene, polyvinylidene fluoride, or a combination thereof.

The rechargeable lithium battery may be fabricated as follows.

An electrode assembly including the positive electrode, negative electrode and a separator interposed between the positive electrode and negative electrode may be put into a battery case, and then, the electrolyte may be injected to fabricate a battery precursor. The battery precursor may undergo a formation process by charging and discharging several times at an about 3.0V to about 4.2V relative to a lithium metal. Thereby, a rechargeable lithium battery, including a SEI passivation film having a specific average thickness of about 1 nm to about 20 nm formed on the surface of the positive electrode, may be fabricated. The SEI passivation film may have a specific composition as well as a specifically ranged average thickness.

When the fabricated rechargeable lithium battery that undergoes the formation process is charged at about 3.3V to about 4.0V, the SEI passivation film may include about 50 wt % to about 90 wt % of the LiF, and specifically, about 75 to about 85 wt % based on a total weight of the SEI passivation film. When the fabricated rechargeable lithium battery is discharged at about 3.3V to about 4.0V, the SEI passivation film may include about 50 wt % to about 90 wt % of LiF, and specifically, about 75 wt % to about 85 wt % of LiF based on a total weight of the SEI passivation film. As described, during charge and discharge, a composition of SEI passivation films may be different from each other. When each SEI passivation film has a composition at the above ranges, the rechargeable lithium battery may realize excellent battery performance even during high-rate charge and discharge.

The following Examples and Comparative Examples are provided in order to set forth particular details of one or more embodiments. However, it is to be understood that the embodiments are not limited to the particular details described. Further, the Comparative Examples are set forth to highlight certain characteristics of certain embodiments, and are not to be construed as either limiting the scope thereof as exemplified in the Examples or as necessarily being outside the scope thereof in every respect.

Furthermore, what is not described in this specification can be sufficiently understood by those who have knowledge in this field and will not be illustrated here.

### EXAMPLE 1

LiCoO₂ having an average particle diameter of 5 μm, carbon black, and polyvinylidenefluoride were mixed in a weight ratio of 96:2:2 in N-methyl pyrrolidone, preparing a positive active material layer composition. The positive active material layer composition was coated onto an aluminum foil, dried, and compressed, fabricating a positive electrode. The positive electrode and lithium metal as a counter electrode were housed in a battery container, and an electrolyte solution was injected therein, fabricating a coin cell. The electrolyte was prepared by mixing ethylene carbonate (EC), dimethylcarbonate (DMC), and diethylcarbonate (DEC) in a volume ratio of 3:3:4 and dissolving LiPF₆ therein in a concentration of 1.2M.

The coin cell was charged at 3.5V for 3 hours relative to the lithium metal and then, charged and discharged ten times at 0.1 C/0.1 C in a range of 3.5V to 4.2V for a formation process.

### EXAMPLE 2

A coin cell was fabricated through a formation process according to the same method as Example 1, except for charging the coin cell at 3.7V for 3 hours relative to lithium metal and charging/discharging ten times at 0.1 C/0.1 C in a range of 3.5V to 4.2V.

### EXAMPLE 3

A coin cell was fabricated through a formation process according to the same method as Example 1, except for charging the coin cell at 3.7V for 1 hour relative to lithium metal and charging/discharging ten times at 0.1 C/0.1 C in a range of 3.5V to 4.2V.

### COMPARATIVE EXAMPLE 1

A coin cell was fabricated according to the same method as Example 1, except for performing no formation process.

### COMPARATIVE EXAMPLE 2

A coin cell was fabricated through a formation process according to the same method as Example 1, except for charging the cell at 2.8V for 1 hour relative to lithium metal and then, charging and discharging ten times at 0.1 C/0.1 C in a range of 2.8V to 4.3V.

### COMPARATIVE EXAMPLE 3

A coin cell was fabricated through a formation process according to the same method as Example 1, except for charging the cell at 4.3V for 1 hour relative to a lithium metal and then, charging and discharging ten times at 0.1 C/0.1 C in a range of 2.8V to 4.3V.

### EXAMPLE 4

A coin cell was fabricated through a formation process according to the same method as Example 1, except for mixing LiNi_{0.8}Co_{0.15}Al_{0.05}O₂ (instead of LiCoO₂), carbon black and polyvinylidenefluoride in a weight ratio of 96:2:2 in N-methyl pyrrolidone to prepare the positive active material layer composition.

### EXAMPLE 5

A coin cell was fabricated through a formation process according to the same method as Example 4, except for charging the cell at 3.7V for 3 hours relative to lithium metal and then, charging and discharging ten times at 0.1 C/0.1 C in a range of 3.5V to 4.2V.

### EXAMPLE 6

A coin cell was fabricated through a formation process according to the same method as Example 4, except for charging the cell at 3.7V for 1 hour relative to a lithium metal and then, charging and discharging ten times at 0.1 C/0.1 C in a range of 3.5V to 4.2V.

### COMPARATIVE EXAMPLE 4

A coin cell was fabricated according to the same method as Example 4, except for performing no formation process.

### EXAMPLE 7

LiFePO₄, carbon black, and polyvinylidenefluoride were mixed in a weight ratio of 96:2:2 in N-methyl pyrrolidone, preparing a positive active material layer composition. The positive active material layer composition was coated onto an aluminum foil, dried, and compressed, fabricating a positive electrode. The positive electrode and lithium metal as a counter electrode were housed in a battery container, and an electrolyte was injected therein, fabricating a coin cell. The electrolyte was prepared by mixing ethylene carbonate (EC), dimethylcarbonate (DMC), and diethylcarbonate (DEC) in a volume ratio of 3:3:4 and dissolving LiPF₆ therein in a concentration of 1.2M.

The coin cell was charged at 3.15V for 3 hours relative to the lithium metal and then, charged and discharged ten times with 0.1 C/0.1 C in a range of 3.15V to 4.2V for a formation process.

### EXAMPLE 8

A coin cell was fabricated through a formation process according to the same method as Example 7, except for charging the coin cell at 3.25V for 3 hours relative to lithium metal and charging/discharging ten times at 0.1 C/0.1 C in a range of 3.15V to 4.2V.

### EXAMPLE 9

A coin cell was fabricated through a formation process according to the same method as Example 7, except for charging the coin cell at 3.25V for 1 hour relative to lithium metal and charging/discharging ten times at 0.1 C/0.1 C in a range of 3.15V to 4.2V.

### COMPARATIVE EXAMPLE 5

A coin cell was fabricated according to the same method as Example 7, except for performing no formation process.

Evaluation 1: Composition and Thickness of SEI Passivation Film on Surface of Positive Electrode

The composition and thickness of the SEI passivation films on the surface of the positive electrodes according to Examples 1 to 9 and Comparative Examples 1 to 5 were measured. The results are provided in the following Table 1.

The composition and thickness of the SEI passivation films were measured using film analysis equipment. The film analysis equipment consisted of a first analyzer having an inert chamber and X-ray Photoelectron Spectroscopy (XPS) equipment and a second analyzer having an inert holder and a scanning electron microscope (SEM). The inert chamber was maintained under an inert atmosphere controlled to have moisture ranging from 0 ppm to 0.1 ppm and oxygen ranging from 0 ppm to 0.5 ppm. The first analyzer, the inert holder, and the second analyzer were all maintained under the inert atmosphere.

The rechargeable lithium battery cells according to Examples 1 to 6 and Comparative Examples 1 to 5 were pretreated under the inert chamber after the formation process. The pretreatment was performed by obtaining an electrode by disassembling the rechargeable lithium battery cells, cutting an electrode therein into a predetermined size to take a specimen having a SEI passivation film, and cleaning the specimen. The specimen was put into the first analyzer and analyzed through XPS to determine an average thickness and composition of the SEI passivation film. Herein, when the specimen was ion-etched in the first analyzer, an ion beam was radiated until the positive electrode material was reduced to 60 atom % based on the total amount of the original positive electrode material. Then, the specimen was transferred to the inert chamber and assembled with the inert holder. Then, the inert holder was mounted on the second analyzer to analyze the SEI passivation film. An electron beam having an accelerating voltage of 1 kV was radiated from the second analyzer.

Evaluation 2: High-Rate Charge and Discharge Characteristic of Rechargeable Lithium Battery Cells

The coin cells according to Examples 1 to 9 and Comparative Examples 1 to 5 were charged and discharged after the formation process. The coin cells were charged at 0.2 C from 1.5V to 0.01V by a constant current constant voltage method and then, an initial discharge capacity was measured. Then, the coin cells were charged at 0.2 C at 0.01V and discharged at 5 C up to 1.5V, and a discharge capacity was measured to evaluate output characteristics. In addition, the coin cells were respectively charged and discharged at 5 C/5 C and percentages of discharge capacity at 5 C and the 50^{th} cycles relative to discharge at the initial 0.2 C were calculated to obtain a capacity retention (%). The results are provided in the following Table 1.

TABLE 1

| | Thickness of | | | Discharge | |
|---|---|---|---|---|---|
| | SEI | LiF amount of SEI | Initial discharge | capacity at 5 C | Capacity |
| | passivation | passivation film | capacity (0.2 C) | after charge at | retention |
| | film (nm) | components (wt %) | (mAh/g) | 0.2 C (mAh/g) | (%) |
| Example 1 | 13 | 82 | 153 | 123 | 34 |
| Example 2 | 11 | 80 | 154 | 125 | 28 |
| Example 3 | 15 | 83 | 152 | 121 | 33 |
| Comparative | 21 | 48 | 153 | 113 | 21 |
| Example 1 | | | | | |
| Comparative | 25 | 25 | 152 | 111 | 23 |
| Example 2 | | | | | |
| Comparative | 31 | 48 | 149 | 105 | 19 |
| Example 3 | | | | | |
| Example 4 | 5 | 84 | 189 | 138 | 35 |
| Example 5 | 8 | 80 | 192 | 135 | 38 |
| Example 6 | 5 | 85 | 188 | 138 | 33 |
| Comparative | 21 | 42 | 187 | 124 | 26 |
| Example 4 | | | | | |
| Example 7 | 19 | 77 | 146 | 115 | 35 |
| Example 8 | 15 | 75 | 145 | 117 | 33 |
| Example 9 | 18 | 74 | 144 | 114 | 32 |
| Comparative | 25 | 45 | 143 | 98 | 23 |
| Example 5 | | | | | |

As shown in Table 1, it may be seen that the coin cells of Examples 1 to 9 obtained by the formation process of charging and discharging the coin cells for several times at a range of about 3.0V to about 4.2V relative a lithium metal were formed with a SEI passivation film having an average thickness of 1 nm to 20 nm on the surface of positive electrode, and the SEI passivation film included 50 wt % to 90 wt % of LiF component. On the other hand, it may be seen that the coin cells according to Comparative Examples 1, 4 and 5 which did not undergo the formation process and Comparative Examples 2 and 3 which underwent the formation process outside of the voltage range were formed with the SEI passivation film having an average thickness of greater than 20 nm on the surface of positive electrode.

In addition, Examples 1 to 3 showed higher 5 C discharge capacity compared to Comparative Examples 1 to 3; Examples 4 to 6 showed higher 5 C discharge capacity than Comparative Example 4; Examples 7 to 9 showed higher 5 C discharge capacity than Comparative Example 5.

Furthermore, Examples 1 to 3 showed higher 5 C/0.2 C capacity retention than Comparative Examples 1 to 3; Examples 4 to 6 showed higher 5 C/0.2 C capacity retention than Comparative Example 4; Examples 7 to 9 showed higher 5 C/0.2 C capacity retention than Comparative Example 5. According to an embodiment, it is understood that the surface resistance may be decreased by forming a SEI passivation film having a predetermined thickness on the surface of positive electrode, so as to improve the cycle-life characteristic.

By way of summation and review, when a negative active material includes amorphous carbon and graphite, lithium ions are intercalated into the carbon of a negative electrode and form a SEI (solid electrolyte interface) film on the surface thereof. The SEI passivation film forms a kind of membrane allowing lithium ions, but not electrons, to pass. The SEI passivation film helps the negative electrode work properly.

A high-capacity battery may be slowly charged and discharged at low C-rate to full charge and full discharge at a voltage between about 3V to about 4.3V. Accordingly, the active material may not undergo abrupt lattice changes. In this case, an additive of preventing decomposition of the electrolyte solution, for example, vinylene carbonate (VC), fluoroethylene carbonate (FEC), and the like may be added to the active material to form a thin SEI passivation film and thus, suppressing the decomposition of the electrolyte.

The battery performance may be considerably affected by the SEI passivation film when the SEI passivation film is formed on the surface of negative electrode. However, the battery performance may be insignificantly affected by an SEI passivation film formed on the surface of positive electrode. Accordingly, little attention has been paid to SEI passivation films with respect to positive electrodes.

However, unlike the high-capacity battery, a high rate output/high rate input battery transports charge at a ten-fold C-rate, and ions are transported in about several tens of seconds to several minutes. A excessively thick SEI passivation film, which may be formed on the surface of an active material with long cycles may become a resistance accumulating factor, which may remarkably effect the deterioration of the high-rate input and output battery. Accordingly, it is desirable to redesign the surface of an active material in view of an increasing request of high rate output/high rate input characteristics and the like from consumers.

The growing of a SEI passivation film on the surface of positive electrode, which may not be a serious problem at in a battery with a low rate charge and discharge, may become a significant problem affecting the performance of a high-rate input and output battery. Ions may be transported in faster as the viscosity of an electrolyte (including a salt) decreases considering the characteristics of high-rate input and output battery. Accordingly, when the salt of extreme high concentration of 2M or more is used, the thickness of a SEI passivation film may be appropriately controlled, but the viscosity of electrolyte solution is increased, thereby deteriorating the performance in the same manner.

Embodiments may provide a positive electrode for a lithium rechargeable battery that may be operated during high-rate charging and discharging without degradation. By using electrochemical characteristics of forming LiF components at a specific voltage range, a SEI passivation film may be artificially formed to have an average thickness within a specific range and also, to have a predetermined composition on the surface of the positive electrode through a process in which a rechargeable lithium battery is charged and discharged several times in a specific voltage range. The passivation film formed thereby may help to prevent a condition in which components of a passivation film, such as LiF and the like, are detached from the surface of a positive active material during high-rate charge and discharge and grow a new, thicker film on the surface of the positive active material exposed to an electrolyte solution through a reduction reaction with the electrolyte solution. Accordingly, a rechargeable lithium battery having excellent battery performance during the high-rate charge and discharge may be provided.

Example embodiments have been disclosed herein, and although specific terms are employed, they are used and are to be interpreted in a generic and descriptive sense only and not for purpose of limitation. Accordingly, it will be understood by those of skill in the art that various changes in form and details may be made without departing from the spirit and scope thereof as set forth in the following claims.

What is claimed is:

1. A positive electrode for a rechargeable lithium battery, the positive electrode comprising:
a positive active material layer comprising a positive active material, and
a solid electrolyte interface (SEI) passivation film on a surface of the positive active material layer, the SEI passivation film including an inorganic material and an organic material, the SEI passivation film having an average thickness of about 1 nm to about 20 nm on a surface of the positive electrode.

2. The positive electrode for a rechargeable lithium battery as claimed in claim 1, wherein the positive active material includes at least one lithium composite oxide selected from LiCoO₂, LiₐNi_{b}Co_{c}Al_{d}O₂ (0.9≦a≦1.1, 0.1≦b≦2.0, 0.01≦c≦1.0, 0.01≦d≦1.0, b+c+d=1), and LiFePO₄.

3. The positive electrode for a rechargeable lithium battery as claimed in claim 2, wherein the positive active material further includes activated carbon.

4. The positive electrode for a rechargeable lithium battery as claimed in claim 1, wherein:
a first layer of the SEI passivation film includes the organic material in an amount greater than or equal to about 90 wt % and the inorganic material in an amount of less than or equal to about 10 wt %, and
a second layer of the SEI passivation film includes the inorganic material in an amount greater than or equal to about 80 wt % and the organic material in an amount of less than or equal to about 20 wt %,
the first layer and the second layer being determined according to a division of the SEI passivation film based on an equal thickness, the first layer being in a positive active material direction from a surface of the SEI passivation film and the second layer being between the first layer and the positive active material.

5. The positive electrode for a rechargeable lithium battery as claimed in claim 1, wherein:
the inorganic material includes at least one selected from LiF, Li₂O, Li₂CO₃ and LiₓPF_{y}O (0≦x≦1, 1≦y≦4), and
the organic material includes at least one selected from:
ROCO₂Li, where R is a C1 to C10 alkyl group,
R¹(OCO₂CH₂CH₂)ₙLi, where R¹ is a C1 to C10 alkyl group, and n is an integer ranging from about 1 to about 25,
R²(CH₂CH₂O)ₘLi, where R² is a C1 to C10 alkyl group, and m is an integer ranging from about 1 to about 25, and
NR³R⁴R⁵, where R³, R⁴ and R⁵ are C1 to C10 alkyl groups.

6. The positive electrode for a rechargeable lithium battery as claimed in claim 5, wherein the SEI passivation film includes about 50 to about 90 wt % of LiF based on a total weight of the SEI passivation film.

7. The positive electrode for a rechargeable lithium battery as claimed in claim 5, wherein:
a first layer of the SEI passivation film includes NR³R⁴R⁵, where R³, R⁴ and R⁵ are C1 to C10 alkyl groups, in an amount greater than or equal to about 90 wt % based on a total weight of the first layer, and
a second layer of the SEI passivation film includes LiF in an amount greater than or equal to about 80 wt % based on a total weight of the second layer,
the first layer and the second layer being determined according to a division of the SEI passivation film based on an equal thickness, the first layer being in a positive active material direction from a surface of the SEI passivation film and the second layer being between the first layer and the positive active material.

8. A rechargeable lithium battery, comprising:
the positive electrode as claimed in claim 1;
a negative electrode; and
an electrolyte.

9. The rechargeable lithium battery as claimed in claim 8, wherein the SEI passivation film on the surface of the positive electrode is formed through a formation process in which the rechargeable lithium battery is charged and discharged several times at an about 3.0V to about 4.2V relative to a lithium metal.

10. The rechargeable lithium battery as claimed in claim 9, wherein, when the rechargeable lithium battery is charged at about 3.3V to about 4.0V after the formation process, the SEI passivation film includes about 50 to about 90 wt % of LiF based on a total weight of the SEI passivation film.

11. The rechargeable lithium battery as claimed in claim 9, wherein when the rechargeable lithium battery is discharged at about 3.3V to about 4.0V after the formation process, the SEI passivation film includes about 50 to about 90 wt % of LiF based on a total weight of the SEI passivation film.

12. A method of preparing a rechargeable lithium battery, the method comprising:
providing a battery precursor including an electrode assembly, a positive electrode including a positive active material, a negative electrode and an electrolyte in a battery case; and
performing a formation process where the battery precursor is charged and discharged at an about 3.0V to about 4.2V region relative to a lithium metal to form a solid electrolyte interface (SEI) passivation film including an inorganic material and an organic material and having an average thickness of about 1 nm to about 20 nm on a surface of the positive electrode.

13. The method as claimed in claim 12, further comprising charging the rechargeable lithium battery at about 3.3V to about 4.0V after the formation process,
wherein the SEI passivation film after the charging includes about 50 to about 90 wt % of LiF based on a total weight of the SEI passivation film.

14. The method as claimed in claim 12, further comprising discharging the rechargeable lithium battery at about 3.3V to about 4.0V after the formation process,
wherein the SEI passivation film after the discharging includes about 50 to about 90 wt % of LiF based on a total weight of the SEI passivation film.
